(19) United States
(12) Patent Application Publication
(10) Pub. No.: US 2008/0124625 A1
(43) Pub. Date: May 29, 2008

(54) Casing For a Sealed Battery

(75) Inventors: David Hock, Castel Rock, CO (US); Kurt Jensen, Aurora, CO (US); Neil Puester, Aurora, CO (US)

Correspondence Address: CAPITOL PATENT & TRADEMARK LAW FIRM, PLLC, PO BOX 1210, VIENNA, VA, 22183, US

(73) Assignee: Nilar International AB

(21) Appl. No.: 11/597,294

(22) PCT Filed: Mar. 20, 2006
(86) PCT No.: PCT/SE06/00347

§ 371 Date: Jul. 6, 2007

(30) Foreign Application Priority Data
Apr. 1, 2005 (SE) 0500718-2

(51) Int. Cl. H01M 2/02

(52) U.S. Cl. 429/176

(57) ABSTRACT

The present invention relates to a casing 10 for a sealed bipolar battery 20, 30, 50, 55, 60 comprising at least one battery cell 21, wherein each cell have electrodes with non-metallic substrates. The casing comprises at least two parts, an upper part 12, 31, 41, 61 and a lower part 11, 51, 62, that are joined together to form the casing of the battery. A mechanically compliant arrangement are built-in to the casing to reduce the forces on the cell stack caused by changes in cell thickness during operation, and a pressure means are built-in to the casing to distribute the pressure across the cell stack.

### TECHNICAL FIELD

The present invention relates to a casing for a sealed bipolar battery, especially for a battery comprising electrodes with non-metallic substrates, as defined claim 1.

### BACKGROUND TO THE INVENTION

A sealed bipolar battery, e.g. a NiMH bipolar battery, having a plurality of battery cells arranged in an electrochemical bipolar cell stack must have a casing that bears the forces that the cell stack applies to the casing. Each battery cell in a bipolar battery comprises a negative electrode and a positive electrode with a separator arranged between them. Each cell is separated from other cells by an electrically conductive biplate, and a positive endplate and negative endplate, respectively, are arranged on each side of the cell stack.

Various mechanical casing and support methods have been used to direct and control the forces that are need for proper operation of an electrochemical bipolar cell stack.

In the granted U.S. Pat. No. 5,547,777 by Richards, a bipolar fuel cell stack is disclosed which uses rigid endplates, tie rods, and mechanically compliant pads. While this mechanical approach to managing the forces on a cell stack can be effective, it is a heavy and bulky solution that is not cost effective for mass manufacturing.

In the granted U.S. Pat. No. 6,689,503 by Yang, a fuel cell stack is also disclosed with rigid endplates and tie rods. However, here a bellows containing a pressurized fluid is disclosed as the mechanically compliant element. This approach has similar weight, volume and cost drawbacks, in addition to the need to provide the pressurized fluid to the bellows.

In the granted U.S. Pat. No. 5,393,617 by Klein, a bipolar battery is disclosed that uses either sponge rubber, a spring, or a gas filled compressible pad as the compliant element in the stack. The inclusion of such an additional complaint part in the finished battery assembly can be detrimental to the cost, volume and weight of the resulting battery assembly.

### SUMMARY OF THE INVENTION

An object of the present invention is to provide a casing for a sealed bipolar battery having a battery stack that can maintain adequate and adequately uniform pressure across the battery compared to prior art casings.

This object is achieved by the features in defined in claim 1.

An advantage with the present invention is that it is less expensive to manufacture, can result in a smaller part count in a finished battery assembly, and can result in less weight and volume in the finished battery for a given cell stack. This is especially advantageous for batteries comprised of a smaller cell stack, where the casing typically occupies a larger fraction of the total weight and volume of the finished assembly when compared to batteries made with a larger cell stack.

Another advantage is that the present invention provides a casing where externally applied means are not necessary to maintain the shape of the battery casing, which in turn will reduce the cost for manufacturing the battery.

Further objects and advantages of the present invention will be apparent to those skilled in the art from the following detailed description of the disclosed casing for a sealed battery.

### BRIEF DESCRIPTION OF THE DRAWINGS

The different embodiments shown in the appended drawings are not to scale or proportion, but exaggerated to point out different important features for the sake of clarity.

FIG. 1 shows a first embodiment of a casing according to the invention.

FIG. 2 shows an assembled bipolar battery having a casing as described in connection with FIG. 1.

FIG. 3 shows a second embodiment of a casing according to the invention together with a bipolar battery.

FIG. 4 shows a perspective view of the corrugated lid as described in FIG. 3.

FIG. 5 shows a cross-sectional view of an alternative lid according to the invention.

FIG. 6 shows a third embodiment of a casing according to the invention together with a bipolar battery.

FIG. 7 shows a fourth embodiment of a casing according to the invention together with a bipolar battery.

FIG. 8 shows a perspective view of an assembled bipolar battery according to the invention.

### DETAILED DESCRIPTION OF PREFERRED EMBODIMENTS

A sealed bipolar battery having a plurality of battery cells arranged in a cell stack must have a casing that bears the forces that the cell stack applies to the casing. It must do in a way that:
1) The casing does not fail (i.e. the casing materials and fastening must not break open during battery operation).
2) The casing must maintain adequate and adequately uniform pressure across the cell stack.
3) The casing must maintain the dimensions of the cell stack within some tolerances during battery operation.

Each battery cell in a bipolar battery comprises a negative electrode and a positive electrode with a separator arranged between them. Each electrode comprises a non-metallic substrate, which make them less expensive. Each cell is separated from each other by an electrically conductive biplate, and a positive endplate and negative endplate, respectively, are arranged on each side of the cell stack. The battery is preferably provided with a common gas space, disclosed in the published international patent application WO 03/026042, assigned to the same applicant, to distribute the pressure within the battery due to gassing, but the present invention may be implemented in a bipolar battery having at least one separately arranged battery cell.

Upon initial electrical cycling of the bipolar battery, the electrodes will irreversibly swell. The swelling of the electrodes can produce huge forces when contained in a stiff casing because the elastic modulus of the electrodes themselves is very high. This can lead to crushed separators and fracture yield of lower cost casing materials, such as thermoplastics.

To mitigate these excessive forces, something in the battery assembly may be deliberately situated in the assembly to be mechanically compliant, i.e. of relatively lower elastic modulus and not as stiff as the electrodes and biplates, so that the forces on the cell stack do not change too much when a dimensional change occurs in the electrodes. In the prior art, as mentioned in the background to the invention, compliant pads or other such compliant parts could be provided on the outside of the endplates. In the present invention the mechanically compliant arrangement is instead built-in to the casing. If increased mechanical compliance is desired in the design of the battery assembly, such additional compliant parts may optionally also be used in addition, as described in connection with FIG. 7. A low-cost casing with built-in mechanical compliance that can provide the necessary mechanical preloaded forces to the electrode stack after battery assembly may be provided by shaping at least one casing part wall in a concave manner in toward the cell stack before assembly. One or both of the casing part surfaces which will be in contact with the electrode stack may be given this shape. This shape when compressed will flatten due to applied force across the face. The casing face in essence, acts in the same manner as a planar leaf spring. The upper case part, cell stack, and lower case part can then be assembled together by applying an external force in the direction perpendicular to the electrode face, and then fastening the casing parts to each other while this force is applied. The external force may then be removed, so that the preloaded force on the face of the electrode stack is now borne by tension in the material comprising the peripheral edge of the casing. Typically, the fastening is accomplished somewhere in this periphery, so the fastening must be capable of bearing this force as well. The periphery may in general be part of the upper and lower case parts, or they may be different parts entirely. Any mechanical arrangement which bears the tension due to a preloaded case face with built-in mechanically compliance around the cell stack to the opposing case face is in the spirit of this invention.

The geometry of the concave shape is chosen to generate the amount of desired preloaded force that should be applied to the electrode stack when compressed. Under a certain range of preloaded compressive force, the shape of the casing in contact with the face of the electrode stack becomes substantially flat. Under this flat condition, the force distribution across the face of the electrode stack becomes substantially uniform as well, due to the uniform elastic properties of the electrode stack itself in the direction perpendicular to the electrode face.

The amount of preloaded force in the case at assembly time can then be chosen such that the case will become substantially flat after the electrode stack has undergone the irreversible swelling that occurs upon initial electrical cycling.

It should be noted that the shape of the case under compression need only be sufficiently flat so as to provide a sufficiently uniform force across the face of the electrode stack. Typically there is a range of compression pressures that may be applied to the electrode stack during battery operation that will provide good operating characteristics. With appropriate choice of the geometry of the concave shape and sufficiently homogeneous elastic properties of the electrode stack, small variations in the compressed case face shape away from flatness will cause only small deviations of the applied compressive force within the desired range of compression pressures. Such variations will not then be detrimental to the operation of the battery.

Such a overall concave geometry may be superimposed upon a casing face with smaller scale shaping contained therein, such as a corrugation or a waffle-like shape. This is desirable when the part is to be fabricated in a low-cost molding operation, and there are thickness constraints on the part design due to the use of this fabrication technique. Such smaller scale shaping also can serve to reduce the weight of the part and the amount of material used, with only small concessions in the strength of the part.

Typically, the electrode stack itself has sufficiently rigid endplates, so that if the smaller scale shaping of the case part does not contact the electrode stack endplate continuously over the entire electrode face, the endplate may then sufficiently re-distribute the locally applied pressure into the electrode stack. This is possible if the small scale shaping is sufficiently small. Optionally, another part may be placed between the casing an endplate if needed to sufficiently re-distribute the locally applied pressure into the electrode stack.

If the desired preloaded force in the case during battery assembly and operation is large enough, it may cause local stresses in the case parts that are larger than the yield stress of the material used. As such, careful choice of the smaller scale shape can reduce stress concentrations in the material when under load, and allow a given size of case and choice of material to bear more preloaded force without yielding.

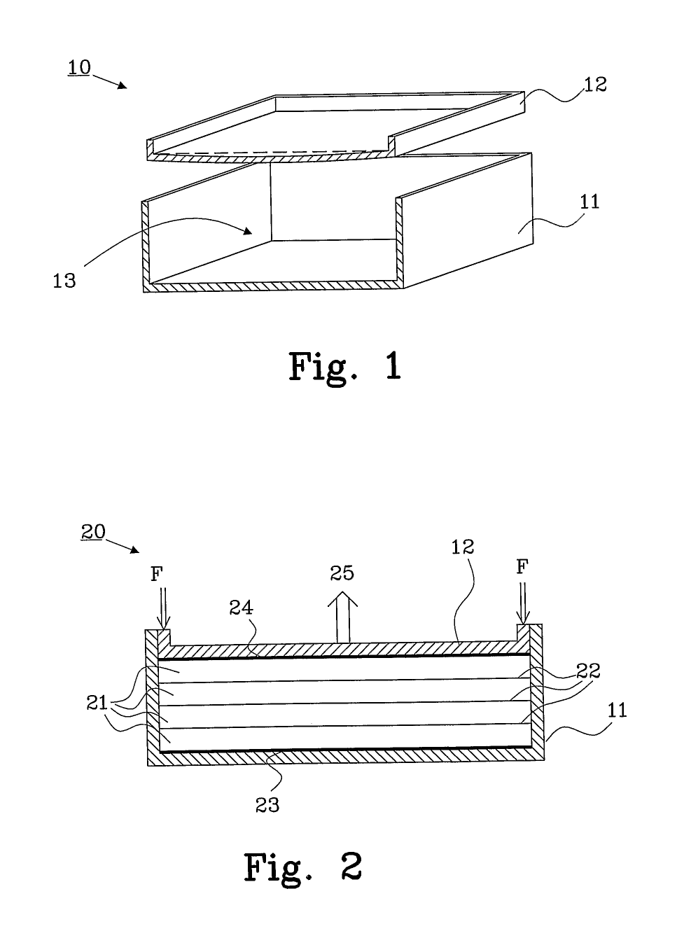

A first embodiment of the present invention is described in connection with FIG. 1, which is a partially cross-sectional view of a non-joined battery casing 10 comprising a lower part 11 and an upper part 12. The upper part 12 is designed to be inserted into the lower part 11 and fasteners (not shown) or a welding will be provided to hold the part together. Battery cells (not shown) arranged in a cell stack will be assembled in the space 13 that is created inside the joined parts 11, 12. Small holes for battery terminal access (not shown) may be provided in the upper part 11 and lower part 12.

In this example the upper part 12, i.e. the lid, is provided with an arrangement that will prevent the casing from breaking and maintaining adequate and adequately uniform pressure across the cell stack. By preloading the part with a spring force, which is the result of creating an inverted pre-bowed shape of the upper part 12, a mechanically compliant arrangement is provided together with an arrangement to distribute the pressure across the cell stack. The lower part 11, the case, could also be provided with an inverted pre-bowed shape which would yield more mechanical compliance, if desired.

The compliant inverted pre-bowed shape, which is then flattened upon mechanical load as described in connection with FIG. 2, addresses all three goals listed above. FIG. 2 shows an assembled sealed bipolar battery 20 having a casing 10 comprising two parts, a case 11 and a lid 12, as disclosed in connection with FIG. 1. A cell stack comprising four cells 21, each separated from one another with a biplate 22, is provided within the casing 10 together with a positive endplate 23 and a negative endplate 24. A common gas space is preferably provided as is known in the prior art. The electrodes are provided with non-metallic substrates as is disclosed in the published international patent application WO2004/042846. The lid 12 is inserted into the case 11 and held in place using a force indicated by the arrows denoted F. Fasteners is then provided around the periphery of the lid to secure the lid 12 to the case 11 and create the casing 10.

By letting the lid 12 deflect somewhat, as indicated by the arrow 25, when the cell stack height changes, the resulting stress in the material of the casing is less than if the casing were stiffer. The lid 12 has an upper boundary on how stiff it can be in order to ensure that the stack forces are below the maximum allowed. There is also a lower boundary on the lid stiffness, most likely set by the allowable deflection of the lid under an additional load of gas pressure originating from gassing in the battery cells.

When the cell stack is flat, the applied load across the face of the cell stack must also be uniform, because the mechanical compliance of the cell components, i.e. electrodes and separators, give a well defined deflection for a given mechanical loading (force/area). Typically the deflection is dominated by the separator, as it is the most compliant material in the stack. If the inverted concave part 12 is flat after the battery assembly and formation, then the load of the cell stack becomes uniform across the face.

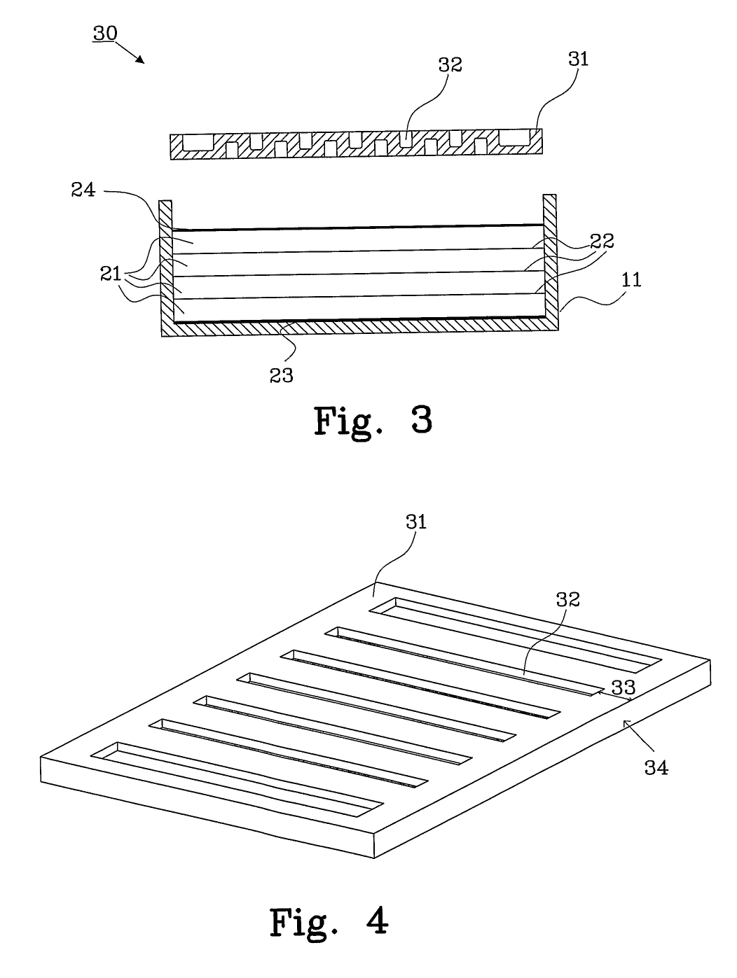

FIG. 3 shows a second embodiment of a casing according to the present invention, comprising a case 11 and a lid 31 that has a corrugated shape, each corrugation is denoted 32. FIG. 3 illustrates the non-joined casing in connection with a bipolar battery 30 during the assembling process, where identical parts of the battery have been denoted with the same reference numerals as in FIG. 2.

The corrugation in the lid 31 face will reduce the stress concentration by a factor of 2-4 times for the same load compared to prior art lids. Depending on the material and area of face, it does have some impact on the stiffness of the face, but it is not always stiffer than a non-corrugated face. The goal of the corrugation is to reduce the magnitudes of stress concentrations, so that they are safely below the material's yield stress.

FIG. 4 shows a perspective view of the lid 31 in FIG. 3, where the corrugations 32 are shown more clearly. The corrugations do not extend across the complete width of the lid 31, and a selected distance 33 is provided between the edge 34 and each corrugation 32. The same applies for the corrugations on the other side of the lid 31.

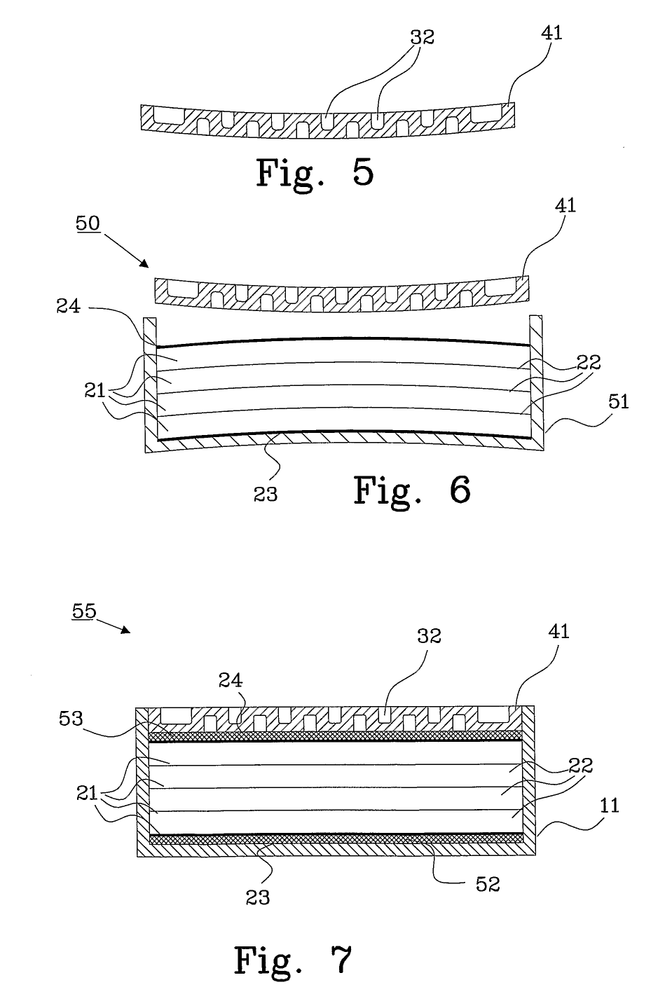

FIG. 5 shows a cross-sectional view of an alternative lid similar to the lid in FIGS. 3 and 4. The lid 41 has, as clearly is shown in the figure, an inverted pre-bowed shape and the corrugations 32 are present on both sides of the lid 41. The corrugations are preferably arranged parallel to the short side of the lid, as shown in FIG. 4, but it is naturally possible to arrange the corrugation in other directions provided that the size of the lid is not too large and dependent on the choice of material.

FIG. 6 shows a cross-sectional view of a sealed bipolar battery 50 having one battery cell arranged inside a case 51 having an inverted pre-bowed shape and a lid 41 as described in connection with FIG. 5. When the lid 41 is attached to the case 51, preferably by using ultrasonic welding, the pressure across the battery cell will be sufficiently uniform and the casing will also be compliant to the pressure changes that will occur inside the battery during operation.

FIG. 7 shows a cross-sectional view of a fourth embodiment of a battery 55 with a casing provided with optional compliant members 52 and 53. The assembly comprises a lower case part 11, a first optional compliant member 52, a positive endplate 23, a cell stack of four cells 21, a negative endplate 24, a second optional compliant member 53 and an upper case part 41. The optional compliant members will function as an extra compliant part in the battery in case the compliance in the casing is not sufficient.

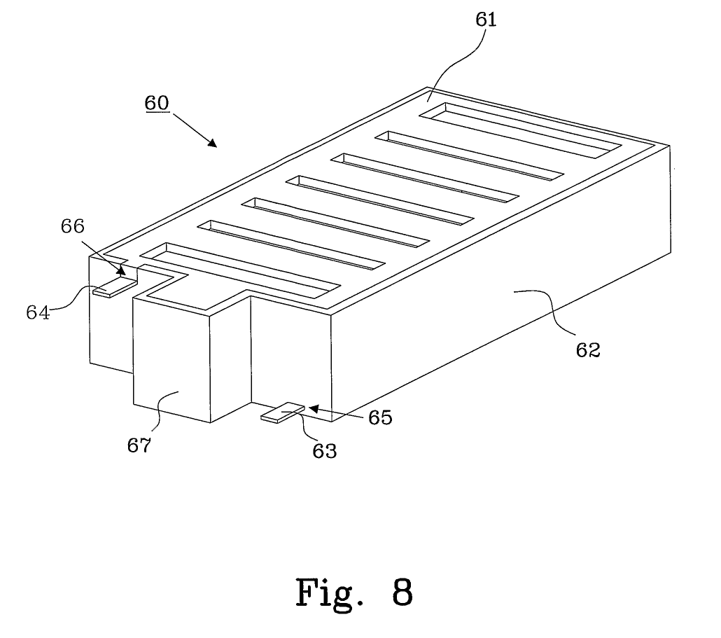

FIG. 8 shows an assembled casing 60 provided with means to connect each endplate inside the battery casing with a positive terminal 63 and a negative terminal 64 without interfering with the resilient and stress distribution function of the lid 61 and the case 62. A hole 65 is provided in the case 62 for the positive terminal connector 63 and a cut-out 66 is provided in the case for the negative terminal connector 64. Furthermore, a divider 67 is provided in the case 62 that will prevent direct electrical contact between the terminals. The lid 61 is constructed to fit to the case 62, including the divider 67 and the cut-out 66. The space created inside divider 67 can be used to arrange means to create a common gas space, if desired.

The wording pressure means used in the independent claim should be interpreted as something that will create a pressure on the components inside the battery when assembled, e.g. a pre-bowed inverted shape of a part of the casing, a corrugated surface of the casing, a combination of corrugation and pre-bowed inverted shape, etc.

The magnitude of a deflection away from flatness of the pre-bowed shape of a casing part while in an unassembled state with no load is preferably at least twice the magnitude of the deflection away from flatness of the same casing part when assembled into a battery and subject to a mechanical preload.

1. A casing for a sealed bipolar battery comprising at least one battery cell, each cell having electrodes with non-metallic substrates, said casing comprises at least two parts, an upper part and a lower part, that are joined together to form the casing of the battery, wherein a mechanically compliant arrangement are built-in to the casing to reduce the forces on the cell stack caused by changes in cell thickness during operation, and a pressure means are built-in to the casing to distribute the pressure across the cell stack.

2. The casing according to claim 1, wherein said built-in pressure means comprises an inverted pre-bowed shape of at least one wall of at least one non-joined part, and a preloaded force, that is derived from the inverted pre-bowed shape, acts on the cell stack within the casing when the parts are joined.

3. The casing according to claim 2, wherein at least one wall of each non-joined part is provided with an inverted pre-bowed shape, and said parts are joined to form a casing with at least two oppositely inverted pre-bowed walls.

4. The casing according to claim 1, wherein said built-in pressure means comprises a reinforcement of at least one wall.

5. The casing according to claim 4, wherein said reinforcement essentially comprises a corrugation of the material forming the wall.

6. The casing according to claim 5, wherein said corrugation is provided parallel to the short side of each wall.

7. The casing according to claim 1, wherein said casing is provided with means to prevent a direct connection between a positive terminal and a negative terminal on the outside of the casing when the parts of the casing are joined.

8. The casing according to claim 1, wherein the parts forming the casing are joined together using ultrasound welding.

9. The casing according to claim 1, wherein said casing is adapted to house a sealed bipolar battery having a plurality of battery cells, in a cell stack, having a common gas space.

10. The casing according to claim 1, wherein said casing additionally comprises one or more mechanically compliant parts in addition to the upper casing part and the lower casing part.
